(19) United States
(12) Patent Application Publication
(10) Pub. No.: US 2025/0191352 A1
(43) Pub. Date: Jun. 12, 2025

(54) OBJECT DETECTION APPARATUS AND METHOD THEREOF

(71) Applicants: Hyundai Motor Company, Seoul (KR); Kia Corporation, Seoul (KR)

(72) Inventors: Jong Won PARK, Hwaseong-Si (KR); Su Rin JO, Hwaseong-Si (KR)

(73) Assignees: Hyundai Motor Company, Seoul (KR); Kia Corporation, Seoul (KR)

(21) Appl. No.: 18/922,915

(22) Filed: Oct. 22, 2024

(30) Foreign Application Priority Data
Dec. 11, 2023 (KR) 10-2023-0179088

(51) Int. Cl. G06V 10/80; G01S 17/89; G06V 10/82

(52) U.S. Cl. CPC G06V 10/80; G01S 17/89; G06V 10/82

(57) ABSTRACT

In an object detection apparatus and a method therefor, the object detection apparatus may include: a processor configured to detect an object based on deep learning using data obtained from LiDAR and to detect the object based on signal processing; and a storage operatively connected to the processor and configured to store algorithms and data driven by the processor, wherein the processor is configured to output a final object detection result by fusing the deep learning-based object detection result and the signal processing-based object detection result.

### CROSS-REFERENCE TO RELATED APPLICATION

The present application claims priority to Korean Patent Application No. 10-2023-0179088, filed on Dec. 11, 2023, the entire contents of which is incorporated herein for all purposes by this reference.

### BACKGROUND OF THE PRESENT DISCLOSURE

### Field of the Present Disclosure

The present disclosure relates to an object detection apparatus and a method therefor, and more particularly, to a fusion technology of an object detection technique based on signal processing and an object detection technique based on deep learning.

### Description of Related Art

For 3D object detection devices using LiDAR, an object detection technique based on signal processing and an object detection technique based on deep learning have been developed.

The object detection technique based on signal processing has the advantage of being easy to apply to actual vehicles through a lightweight recognition algorithm and preventing misrecognition or non-recognition phenomena, but there is a problem in that it is difficult to identify a type of an object and an exact direction of the object, and many objects are separated and fused due to segmentation performance.

The object detection technique based on deep learning has the advantage of being able to accurately predict a size and posture of an object at an object detection step, and has higher classification accuracy than object-level classification by integrating driving situation and surrounding object information, but it is difficult to secure recognition performance for objects that are not included in a learning dataset, and it is difficult to learn a detection network for objects of various shapes and sizes, such as bushes and guardrails.

Accordingly, a conventional object detection technique has shortcomings and needs to be supplemented.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an object detection apparatus and a method therefor, configured for improving object detection performance by fusing an object detection technique based on signal processing and an object detection technique based on deep learning.

An exemplary embodiment of the present disclosure attempts to provide an object detection apparatus and a method therefor, configured for determining and complementing non-recognition and misrecognition of an object detection result based on deep learning by determining association between a detected object recognition result based on signal processing and the object detection result based on deep learning.

An exemplary embodiment of the present disclosure attempts to provide an object detection apparatus and a method therefor, configured for improving object detection performance by generating point information of the object detection result based on deep learning using the detected object recognition result based on signal processing.

The technical objects of the present disclosure are not limited to the objects mentioned above, and other technical objects not mentioned may be clearly understood by those skilled in the art from the description of the claims.

An exemplary embodiment of the present disclosure provides an object detection apparatus including: a processor configured to detect an object based on deep learning using data obtained from LiDAR and to detect the object based on signal processing; and a storage operatively connected to the processor and configured to store algorithms and data driven by the processor, wherein the processor is configured to output a final object detection result by fusing a result of the detecting based on the deep learning and a result of the detecting based on the signal processing.

In an exemplary embodiment of the present disclosure, the processor may be configured to perform bounding box processing on the object detected based on the deep learning and the object detected based on the signal processing, to determine an overlap ratio between a box of the object detected based on the deep learning and a box of the object detected based on the signal processing, and to determine association between the object detected based on the deep learning and the object detected based on the signal processing.

In an exemplary embodiment of the present disclosure, the processor may be configured to determine a deep learning-based overlap ratio based on the result of the detecting based on the deep learning, and to determine a signal processing-based overlap ratio based on the result of the detecting based on the signal processing.

In an exemplary embodiment of the present disclosure, the processor may be configured to determine the deep learning-based overlap ratio and the signal processing-based overlap ratio by use of a total area of the box of the object detected based on the deep learning, a total area of the box of the object detected based on the signal processing, and an overlap area between the box of the object detected based on the deep learning and the box of the object detected based on the signal processing.

In an exemplary embodiment of the present disclosure, the processor may be configured to determine the signal processing-based overlap ratio by dividing the overlap area between the box of the object detected based on the deep learning and the box of the object detected based on the signal processing by a sum of the overlap area of the box of the object detected based on the deep learning and the box of the object detected based on the signal processing, and the total area of the box of the object detected based on the deep learning.

In an exemplary embodiment of the present disclosure, the processor may be configured to determine the deep learning-based overlap ratio by dividing the overlap area between the box of the object detected based on the deep learning and the box of the object detected based on the signal processing by a sum of the overlap area of the box of the object detected based on the deep learning and the box of the object detected based on the signal processing, and the total area of the box of the object detected based on the signal processing.

In an exemplary embodiment of the present disclosure, the processor may be configured to sum up the deep learning-based overlap ratio for each object detected based on the deep learning, and to determine whether the detected object was misdetected based on deep learning by use of a sum of deep learning-based overlap ratios.

In an exemplary embodiment of the present disclosure, the processor may be configured to allow the object detected based on the deep learning to be included in an object detection result in response to a case where the sum of the deep learning-based overlap ratios is greater than a predetermined reference value, and to remove the object detected based on the deep learning from the object detection result in response to a case where the sum of the deep learning-based overlap ratios is equal to or smaller than the predetermined reference value.

In an exemplary embodiment of the present disclosure, the processor may be configured to output a final object detection result by fusing the object detected based on the deep learning and the object detected based on the signal processing included in the object detection result.

In an exemplary embodiment of the present disclosure, the processor may be configured to determine whether each signal processing-based overlap ratio for each object detected based on the signal processing is smaller than a predetermined reference value.

In an exemplary embodiment of the present disclosure, the processor may be configured to allow objects detected based on signal processing to be included in the object detection result in response to a case where the signal processing-based overlap ratio for each object detected based on the signal processing is smaller than the predetermined reference value.

In an exemplary embodiment of the present disclosure, the processor may be configured, in response to a case where there is a value greater than the predetermined reference value among the signal processing-based overlap ratios for each object detected based on the signal processing, to determine whether the object detected based on signal processing is not detected by use of the sum of the signal processing-based overlap ratios for each object detected based on the signal processing.

In an exemplary embodiment of the present disclosure, the processor may be configured to remove the object detected based on signal processing from the object detection result and output the final object detection result using the object detected based on the deep learning in response to a case where the sum of the signal processing-based overlap ratios for each object detected based on the signal processing is greater than the predetermined reference value.

In an exemplary embodiment of the present disclosure, the processor may be configured to allow the object detected based on signal processing to be included in the object detection result in response to a case where the sum of signal processing-based overlap ratios for each object detected based on the signal processing is equal to or smaller than the predetermined reference value.

In an exemplary embodiment of the present disclosure, the processor may be configured to transfer points of the overlap area between the object detected based on signal processing and the object detected based on the deep learning to the object detected based on the deep learning.

An exemplary embodiment of the present disclosure provides an object detection method including: detecting, by a processor, a deep learning-based detection object using data obtained from LiDAR and detecting the object based on signal processing; and outputting, by the processor, a final object detection result by fusing a result of the detecting based on the deep learning and a result of the detecting based on the signal processing.

In an exemplary embodiment of the present disclosure, the detecting of the object may include performing, by the processor, bounding box processing on the object detected based on the deep learning and the object detected based on the signal processing, and the outputting of the final object detection result may include determining, by the processor, the deep learning-based overlap ratio and the signal processing-based overlap ratio by use of a total area of the box of the object detected based on the deep learning, a total area of the box of the object detected based on the signal processing, and an overlap area between the box of the object detected based on the deep learning and the box of the object detected based on the signal processing.

In an exemplary embodiment of the present disclosure, the outputting of the final object detection result may further include: summing up, by the processor, the deep learning-based overlap ratio for each object detected based on the deep learning; and determining, by the processor, whether the detected object was misdetected based on deep learning by use of a sum of deep learning-based overlap ratios.

In an exemplary embodiment of the present disclosure, the outputting of the final object detection result may further include: allowing, by the processor, the object detected based on the deep learning to be included in an object detection result in response to a case where the sum of the deep learning-based overlap ratios is greater than a predetermined reference value; and removing, by the processor, the object detected based on the deep learning from the object detection result in response to a case where the sum of the deep learning-based overlap ratios is equal to or smaller than the predetermined reference value.

In an exemplary embodiment of the present disclosure, the outputting of the final object detection result may further include: determining, by the processor, whether each signal processing-based overlap ratio for each object detected based on the signal processing is smaller than a predetermined reference value; allowing, by the processor, objects detected based on signal processing to be included in the object detection result in response to a case where the signal processing-based overlap ratio for each object detected based on the signal processing is smaller than the predetermined reference value and determining, by the processor, whether the object detected based on signal processing is not detected by use of the sum of the signal processing-based overlap ratios for each object detected based on the signal processing in response to a case where there is a value greater than the predetermined reference value among the signal processing-based overlap ratios for each object detected based on the signal processing.

According to an exemplary embodiment of the present disclosure, it may be possible to improve object detection performance by fusing an object detection technique based on signal processing and an object detection technique based on deep learning.

According to an exemplary embodiment of the present disclosure, it may be possible to determine and complement non-recognition and misrecognition of an object detection result based on deep learning by determining association between a detected object recognition result based on signal processing and the object detection result based on deep learning.

According to an exemplary embodiment of the present disclosure, it may be possible to improve object detection performance by generating point information of the object detection result based on deep learning using the detected object recognition result based on signal processing.

Furthermore, various effects which may be directly or indirectly identified through the present specification may be provided.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a block diagram showing a configuration of an example vehicle system including an object detection apparatus.

FIG. 2 illustrates a view for describing an exemplary object detection structure.

FIG. 3 illustrates a flowchart showing an exemplary object detection method.

FIG. 4A illustrates a view for describing an exemplary object detection process based on deep learning.

FIG. 4B illustrates a view for describing an exemplary object detection process based on signal processing.

FIG. 4C illustrates an example view for describing an exemplary object detection process.

FIG. 5 illustrates a view for describing an exemplary process of determining association between an object detection result based on signal processing and an object detection result based on deep learning.

FIG. 6 illustrates a view for specifically describing an exemplary process of fusing an object detection result based on signal processing and an object detection result based on deep learning.

FIG. 7 illustrates an example of ameliorating a misdetection phenomenon of an object detection technique based on deep learning.

FIG. 8 illustrates an example of ameliorating a non-detection phenomenon of an object detection technique based on deep learning.

FIG. 9 illustrates an example of an object detection result for an irregular object.

FIG. 10 illustrates an example of a final LiDAR object detection result through fusion of an object detection result based on signal processing and an object detection result based on deep learning.

FIG. 11 illustrates an computing system associated with an object detection apparatus or an object detection method.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, some exemplary embodiments of the present disclosure will be described in detail with reference to exemplary drawings. It should be noted that in adding reference numerals to constituent elements of each drawing, the same constituent elements include the same reference numerals as possible even though they are indicated on different drawings. In describing an exemplary embodiment of the present disclosure, when it is determined that a detailed description of the well-known configuration or function associated with the exemplary embodiment of the present disclosure may obscure the gist of the present disclosure, it will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms include the same meanings as those which are generally understood by those skilled in the technical field of the present disclosure to which an exemplary embodiment of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

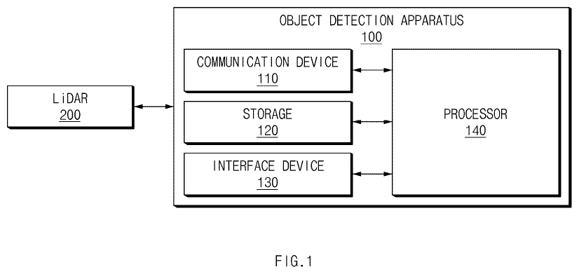

Hereinafter, various exemplary embodiments of the present disclosure will be described in detail with reference to FIG. 1 to FIG. 11.

FIG. 1 illustrates a block diagram showing a configuration of an exemplary vehicle system including an object detection apparatus.

The object detection apparatus 100 according to an exemplary embodiment of the present disclosure may be implemented inside or outside the vehicle. In the instant case, the object detection apparatus 100 may be integrally formed with internal control units of the vehicle, or may be implemented as a separate hardware device to be connected to control units of the vehicle by a connection means. For example, the object detection apparatus 100 may be implemented integrally with the vehicle, may be implemented in a form which is provided or attached to the vehicle as a configuration separate from the vehicle, or a portion thereof may be implemented integrally with the vehicle, and another portion may be implemented in a form which is provided or attached to the vehicle as a configuration separate from the vehicle.

The object detection apparatus 100 may be configured for estimating bounding box information (e.g., a position (x, y, and z), sizes (width, length, and height)), a heading angle, and a class of an object from a Light Detection and Ranging (LiDAR) point cloud through a detection network based on deep learning by use of data obtained through LiDAR 200. The object detection result determined based on deep learning may include the precise size and posture information of the object, in a response to object detection based on deep learning, classification accuracy may be higher than object-level classification by integrating driving situation and surrounding object information, but there may be a high possibility of unrecognized or misrecognized objects that are not included in a learning dataset, and detection accuracy of atypical objects of various shapes and sizes, such as bushes and guardrails, may be low. Deep learning is one of the machine learning methods for teaching artificial intelligence computers, and is a technique that learns by imitating the neural network structure of the human brain.

Furthermore, the object detection apparatus 100 may be configured to detect a signal processing-based detection object by use of data obtained through the LiDAR 200, and to estimate the bounding box information, the size, the heading angle, and the class of the object. A signal processing-based object detection algorithm is easy and simple to apply to real vehicles, and misrecognition and non-recognition phenomena may rarely occur, but classification to identify the object type may be difficult, it may be difficult to determine the precise direction (heading) of the object, and according to segmentation performance, one object may be separated or a plurality of objects may be fused to be detected.

Accordingly, the object detection apparatus 100 according to an exemplary embodiment of the present disclosure may be configured to integratedly detect an object so that advantages may be derived without disadvantages, by fusing an object detection result based on deep learning and an object detection result based on signal processing. That is, the object detection apparatus 100 according to an exemplary embodiment of the present disclosure may be configured to eliminate the non-recognition or misrecognition phenomenon of an object detection technique based on deep learning by use of the object detection result based on signal processing, and to improve recognition accuracy for irregular objects.

Referring to FIG. 1, the object detection apparatus 100 may include a communication device 110, a storage 120, an interface device 130, and a processor 140. According to an exemplary embodiment of the present disclosure, the object detection apparatus 100 may be implemented as a single unit by coupling components with each other, and some components may be omitted.

The communication device 110 is a hardware device implemented with various electronic circuits to transmit and receive signals through a wireless or wired connection, and may transmit and receive information based on in-vehicle devices and in-vehicle network communication techniques. As an exemplary embodiment of the present disclosure, the in-vehicle network communication techniques may include Controller Area Network (CAN) communication, Local Interconnect Network (LIN) communication, flex-ray communication, and the like. As an exemplary embodiment of the present disclosure, the communication device 110 may receive a point cloud from the LiDAR 200 and provide an object detection result inside or outside the vehicle.

The communication device 110 is a hardware device implemented with various electronic circuits to transmit and receive signals through a wireless or wired connection, and may transmit and receive information with internal devices such as vehicles, ships, airplanes, UAMs, and electric kickboards based on network communication techniques. As an exemplary embodiment of the present disclosure, the in-vehicle network communication techniques may include Controller Area Network (CAN) communication, Local Interconnect Network (LIN) communication, flex-ray communication, and the like.

Furthermore, the communication device 110 may include a mobile communication module, a wireless Internet module, a short-range communication module, etc. for communication with outside of the vehicle.

The mobile communication module may be configured to perform communication using technical standards or communication methods for mobile communication (e.g., Global System for Mobile communication (GSM), Code Division Multi Access (CDMA), Code Division Multi Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), 4th Generation mobile telecommunication (4G), 5th Generation mobile telecommunication (5G), etc.

The wireless Internet module refers to a module for wireless Internet access, and may be configured to perform communication through Wireless LAN (WLAN), Wireless-Fidelity (Wi-Fi), Wi-Fi direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), etc.

The short-range communication module may support short-range communication by use of at least one of Bluetooth™, radio frequency identification (RFID), infrared data association (IrDA), ultra wideband (UWB), ZigBee, Near Field Communication (NFC), a wireless universal serial bus (USB) technique, or any combination thereof.

The storage 120 may store detecting results of the detecting device 200 and data and/or algorithms required for the processor 140 to operate, and the like.

For example, the storage 120 may store information (e.g., point cloud data) obtained by the LiDAR 200. As an exemplary embodiment of the present disclosure, the storage 120 may store an algorithm for the object detection based on signal processing, a learning algorithm for the object detection based on deep learning, etc. The storage 120 may store a dataset which is training data. Furthermore, the storage 120 may store an algorithm for fusion of an object detection result based on signal processing and an object detection result based on deep learning.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and an output means for outputting an operation state of the apparatus 100 and results thereof. For example, the interface device 130 may display an LiDAR-based object detection result.

Herein, the input means may include a key button, and may include a mouse, a joystick, a jog shuttle, a stylus pen, and the like. Furthermore, the input means may include a soft key implemented on the display.

The interface device 130 may be implemented as a head-up display (HUD), a cluster, an audio video navigation (AVN), or a human machine interface (HM), a human machine interface (HMI). The output device may include a display, and may also include a voice output means such as a speaker. In the instant case, in a response to a case that a touch sensor formed of a touch film, a touch sheet, or a touch pad is provided on the display, the display may operate as a touch screen, and may be implemented in a form in which an input device and an output device are integrated.

In the instant case, the display may include at least one of a liquid crystal display (LCD), a thin film transistor liquid crystal display (TFT LCD), an organic light-emitting diode display (OLED display), a flexible display, a field emission display (FED), and a 3D display.

The processor 140 may be electrically connected to the communication device 110, the storage 120, the interface device 130, and the like, may electrically control each component, and may be an electrical circuit that executes software commands, performing various data processing and determinations described below.

The processor 140 may be configured to process signals transmitted between each component of the object detection apparatus 100 and to perform overall control so that each component may normally perform function thereof. The processor 140 may be implemented in a form of hardware, software, or a combination of hardware and software. For example, the processor 140 may be implemented as a microprocessor, but the present disclosure is not limited thereto. For example, it may be, e.g., an electronic control unit (ECU), a micro controller unit (MCU), or other subcontrollers mounted in the vehicle.

The processor 140 may be configured to detect an object based on deep learning using data obtained from LiDAR, to detect objects based on signal processing, and to output a final object detection result by fusing the object detection result based on signal processing and the object detection result based on deep learning.

The processor 140 may be configured to perform bounding box processing on the object detected based on the deep learning and the object detected based on the signal processing, to determine an overlap ratio between a box of the object detected based on the deep learning and a box of the object detected based on the signal processing, and to determine association between the object detected based on the deep learning and the object detected based on the signal processing.

The processor 140 may be configured to determine a deep learning-based overlap ratio based on the deep learning-based object detection result, and to determine a signal processing-based overlap ratio based on the signal processing-based object detection result.

The processor 140 may be configured to determine a deep learning-based overlap ratio and a signal processing-based overlap ratio by use of a total area of the box of the object detected based on the deep learning, a total area of the box of the object detected based on the signal processing, and an overlap area between the box of the object detected based on the deep learning and the box of the object detected based on the signal processing.

The processor 140 may be configured to determine the signal processing-based overlap ratio by dividing the overlap area between the box of the object detected based on the deep learning and the box of the object detected based on the signal processing by a sum of the overlap area of the box of the object detected based on the deep learning and the box of the object detected based on the signal processing, and the total area of the box of the object detected based on the deep learning.

The processor 140 may be configured to determine the deep learning-based overlap ratio by dividing the overlap area between the box of the object detected based on the deep learning and the box of the object detected based on the signal processing by a sum of the overlap area of the box of the object detected based on the deep learning and the box of the object detected based on the signal processing, and the total area of the box of the object detected based on the signal processing.

The processor 140 may be configured to sum the deep learning-based overlap ratio for each object detected based on the deep learning, and to determine whether the detected object was misdetected based on deep learning by use of a sum of deep learning-based overlap ratios,

The processor 140 may be configured to allow the object detected based on the deep learning to be included in an object detection result in response to a case where the sum of the deep learning-based overlap ratios is greater than a predetermined reference value, and to remove the object detected based on the deep learning from the object detection result in response to a case where the sum of the deep learning-based overlap ratios is equal to or smaller than the predetermined reference value.

The processor 140 may be configured to output a final object detection result by fusing the object detected based on the deep learning and the object detected based on the signal processing included in the object detection result.

The processor 140 may be configured to determine whether each signal processing-based overlap ratio for each object detected based on the signal processing is smaller than a predetermined reference value.

In response to a case where the signal processing-based overlap ratio for each object detected based on the signal processing is smaller than the predetermined reference value, the processor 140 may be configured to allow the objects detected based on signal processing to be included in the object detection result.

In response to a case where there is a value greater than the predetermined reference value among the signal processing-based overlap ratios for each object detected based on the signal processing, the processor 140 may be configured to determine whether the object detected based on signal processing is not detected by use of the sum of the signal processing-based overlap ratios for each object detected based on the signal processing.

In response to a case where the sum of the signal processing-based overlap ratios for each object detected based on the signal processing is greater than the predetermined reference value, the processor 140 may be configured to remove the object detected based on signal processing from the object detection result and output the final object detection result using the object detected based on the deep learning.

In response to a case where the sum of signal processing-based overlap ratios for each object detected based on the signal processing is equal to or smaller than the predetermined reference value, the processor 140 may be configured to allow the object detected based on signal processing to be included in the object detection result.

The processor 140 may be configured to transfer points of the overlap area between the object detected based on signal processing and the object detected based on the deep learning to the object detected based on the deep learning.

The light detection and ranging (LiDAR) 200 may obtain a point cloud, and may be configured to determine spatial position coordinates (point information) of a reflection point by scanning a laser pulse and measuring an arrival time of the laser pulse reflected from the object.

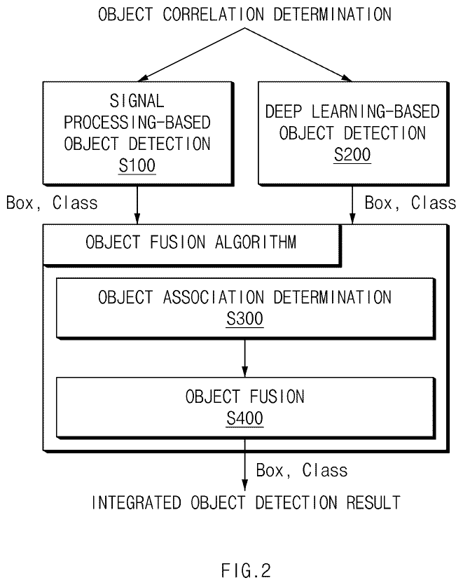

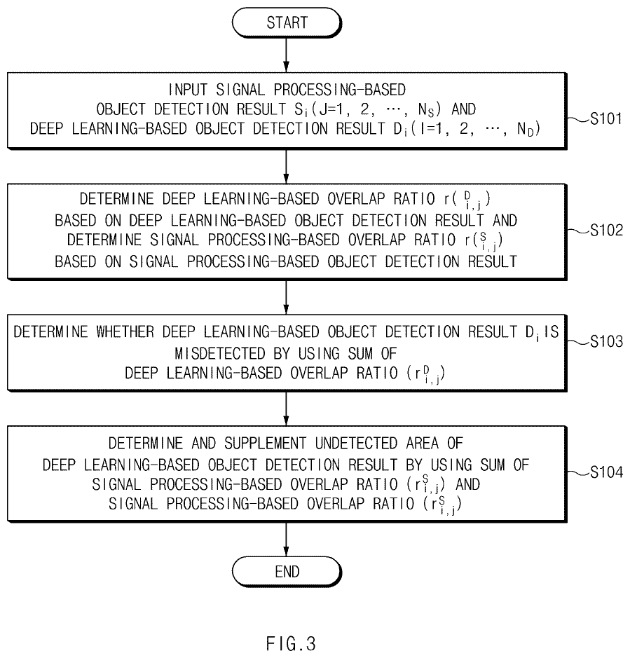

Hereinafter, an overall structure for object detection will be described with reference to FIG. 2 to FIG. 3. FIG. 2 illustrates a view for describing an exemplary object detection structure, and FIG. 3 illustrates a flowchart showing an exemplary object detection method.

Hereinafter, it is assumed that the object detection apparatus 100 of FIG. 1 performs the processes of FIG. 2 and FIG. 3. Furthermore, in the description of FIG. 2 and FIG. 3, operations described as being performed by the device may be understood as being controlled by the processor 140 of the object detection apparatus 100. In following exemplary embodiments of the present disclosure, operations of steps of S100, S200, S300 and S400 and S101, S102, S103 and S104 may be performed sequentially, but are not necessarily performed sequentially. For example, an order of each operation may be changed, and at least two operations may be performed in parallel.

Referring to FIG. 2, the object detection apparatus 100 may be configured to receive a point cloud from the LiDAR 200, and to perform signal processing-based object detection (S100), and deep learning-based object detection (S200).

In the instant case, the signal processing-based object detection result and the deep learning-based object detection result may be formed to include rectangular box information indicating the position and the direction (heading) of the object and class information indicating the type of object.

The object detection apparatus 100 may be configured to determine object association of the signal processing-based object detection result and the deep learning-based object detection result using an object fusion algorithm (S300), and to perform object fusion based on a result thereof and finally display a box and class on the object to output an integrated object detection result.

In the present way, the object detection apparatus 100 according to an exemplary embodiment of the present disclosure may be configured to determine which technique (e.g., a signal processing technique or a deep learning technique) each object was determined using as prior information based on an object-level fusion algorithm, to perform fusion of the results detected by the two technologies.

Referring to FIG. 3 to describe the above-described object detection process in more detail, in response to a case where a signal processing-based object detection result Sⱼ (j=1, 2, . . . , n_{S}) and a deep learning-based object detection result Dᵢ (i=1, 2, . . . , n_{D}) are input (S101), the object detection apparatus 100 may be configured to determine the deep learning-based overlap ratio r_{i,j}^{D} based on the deep learning-based object detection result and determine the signal processing-based overlap ratio r_{i,j}^{S} based on the signal processing-based object detection result (S102). The deep learning-based object detection result Dᵢ (i=1, 2, . . . , n_{D}) and signal processing-based object detection result Sⱼ (j=1, 2, . . . , n_{S}) may refer to each object detected at one moment from the LiDAR 200, and may refer to different objects in one frame. For example, in a case where five vehicles are detected as objects from data obtained through LiDAR 200 at a time point T1, they may be respectively named as D₁, D₂, D₃ D₄, and D₅.

Accordingly, the object detection apparatus 100 may be configured to determine whether the deep learning-based object detection result Dᵢ is misdetected by use of the sum of deep learning-based overlap ratio r_{i,j}^{D} (S103), and to determine and supplement an undetected area of the deep learning-based object detection result by use of the sum of the signal processing-based overlap ratio r_{i,j}^{S} and the signal processing-based overlap ratio r_{i,j}^{S} (S104).

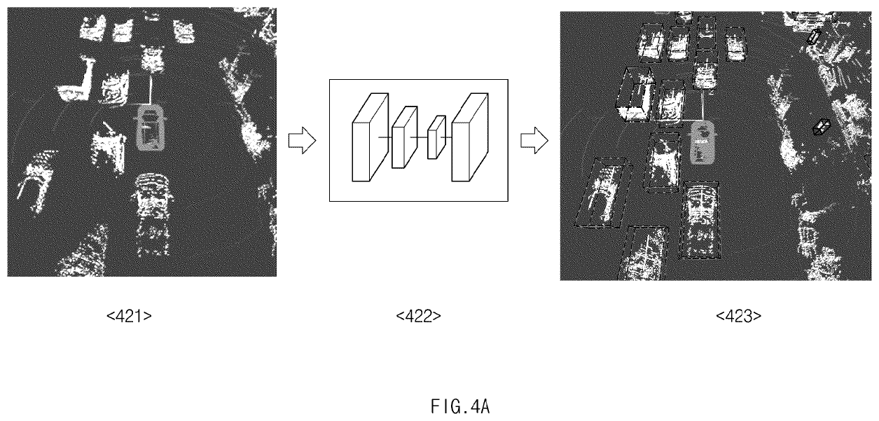

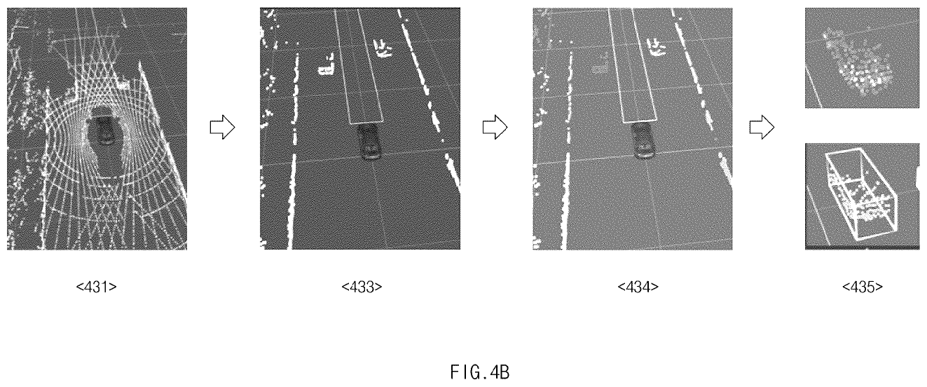

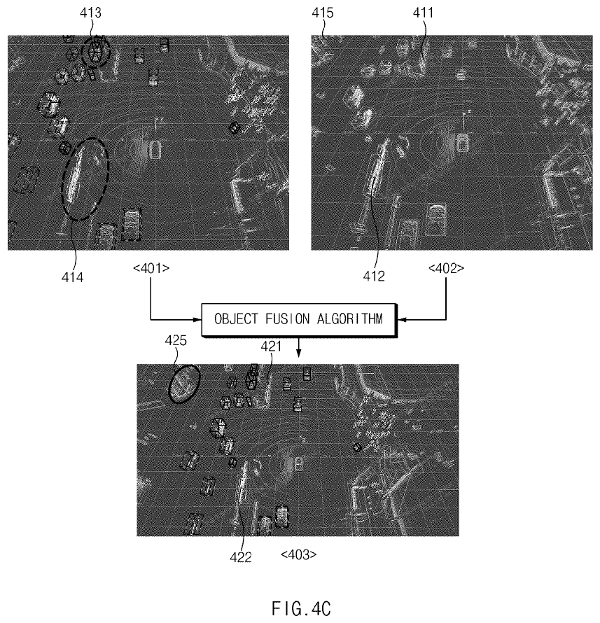

FIG. 4A illustrates a view for describing an exemplary object detection process based on deep learning, and FIG. 4B illustrates a view for describing an exemplary object detection process based on signal processing.

FIG. 4C illustrates an example view for describing an exemplary object detection process.

Referring to FIG. 4A, the object detection apparatus 100 may be configured to input the point cloud (view 421) obtained from the LiDAR 200 to a deep learning network (view 422) in response to detecting a deep learning-based object, and to output boxed object information as an object detection result, as shown in a view 423.

Referring to FIG. 4B, the object detection apparatus 100 may be configured to extract a ground point from a point cloud (view 431) obtained from the LiDAR 200 in response to detecting a signal processing-based object (view 432), to segment the object (view 433), to apply bounding box processing to the segmented object, and to output it (view 434).

Referring to FIG. 4C, a view 401 shows a result of deep learning-based object detection, a view 402 shows a result of signal processing-based object detection, and a view 403 shows a result of fusing the results of the deep learning-based object detection and the signal processing-based object detection.

Comparing the views 401 and 402, it may be seen that objects 411 and 412 boxed in the view 402 are not boxed in the view 401 (see 413 and 414). Furthermore, it may be seen that an object 415 detected in the view 402 is not detected in the view 401.

Accordingly, it may be seen that the object detection apparatus 100 may be configured to fuse the views 401 and 402 and display undetected objects 421, 422, and 425 as boxes on the deep learning-based detection result view 401 as shown in a view 403.

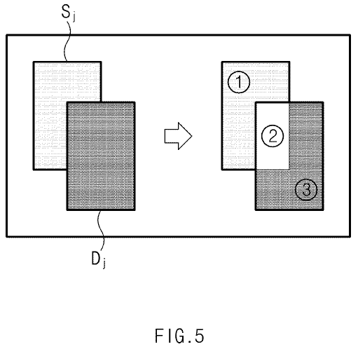

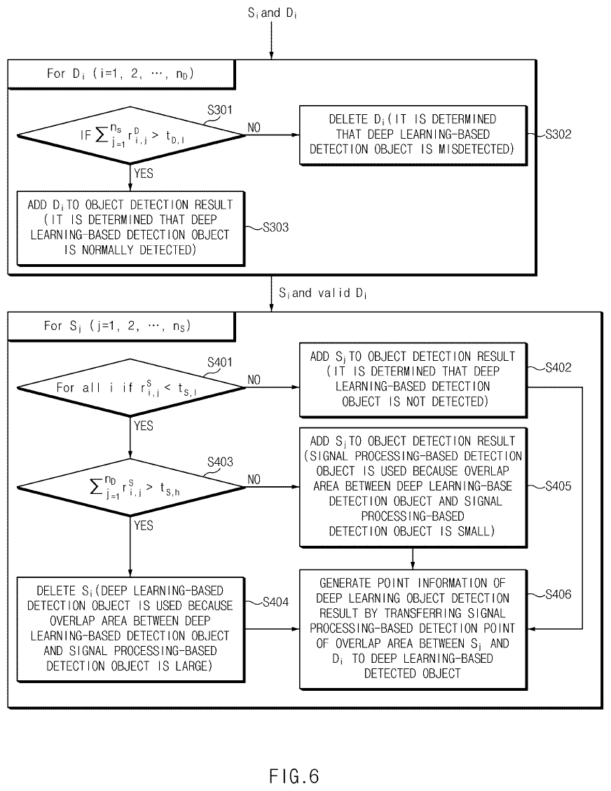

Hereinafter, association determination and a fusion process between the results of the signal processing-based object detection and the deep learning-based object detection will be described in detail with reference to FIG. 5 and FIG. 6. FIG. 5 illustrates a view for describing an exemplary process of determining association between an object detection result based on signal processing and an object detection result based on deep learning, and

FIG. 6 illustrates a view for specifically describing an exemplary process of fusing an object detection result based on signal processing and an object detection result based on deep learning.

Referring to FIG. 5, the object detection apparatus 100 may be configured to determine association between the result of the signal processing-based object detection and the result of the deep learning-based object detection to proceed with the fusion of the result of the signal processing-based object detection and the result of deep learning-based object detection. Accordingly, the object detection apparatus 100 may be configured to pre-select relevant objects according to the results of signal processing-based object detection and deep learning-based object detection, and to use selected association information in response to merging the result of the signal processing-based object detection and the result of deep learning-based object detection.

The object detection apparatus 100 may be configured to determine the association between objects on a bird eye view in which a 3D object detection result is compressed along a z-axis. The object detection apparatus 100 may be configured to determine the association between the signal processing-based detection object and the deep learning-based detection object by use of an occlusion (overlap) ratio of the object detected based on signal processing and the object detected based on the deep learning. In the instant case, the object detection apparatus 100 may be configured to determine two overlap ratios r_{i,j}^{S}, R_{i,j}^{D} for each of the deep learning-based detection object and the signal processing-based detection object, which is a method to divide and determine physical quantities to subdivide a convergence case.

Equation 1 below indicates a formula that determines the signal processing-based overlap ratio r_{i,j}^{S}, and Equation 2 indicates a formula that determines deep learning-based overlap ratio r_{i,j}^{D}.

$${r}_{i , j}^{S} = \frac{area}{area + area} \qquad ( Equation 1 )$$

$${r}_{i , j}^{D} = \frac{area}{area + area} \qquad ( Equation 2 )$$

In FIG. 5, Sⱼ (j=1, 2, . . . , n_{S}) indicates the result of the signal processing-based object detection, Dᵢ (i=1, 2, . . . , n_{D}) indicates the result of the deep learning-based object detection. Furthermore, the signal processing-based overlap ratio (r_{i,j}^{S}) indicates a result of determining how much the box of deep learning-based detection object Dᵢ overlaps the box of signal processing-based detection object Sⱼ, and the deep learning-based overlap ratio r_{i,j}^{D} indicates the result of determining how much the box of the signal processing-based detection object Sⱼ overlaps the box of the deep learning-based detection object Dᵢ.

An area \textcircled{1} indicates a total area of the box of the signal processing-based detection object Sⱼ, an area \textcircled{2} indicates an area of the box area of the signal processing-based detection object Sⱼ that overlaps an area of the box of the deep learning-based detection object Dᵢ, and an area \textcircled{3} indicates a total area of the box of the deep learning-based detection object Dᵢ.

In the present way, the object detection apparatus 100 may be configured to determine a ratio of how much each of the deep learning-based detection object Dᵢ and the signal processing-based detection object Sⱼ overlap each other on opposite sides, to determine association. This is to subdivide fusion cases through two ratios and produce better fusion results.

Referring to FIG. 6, the object detection apparatus 100 may be configured to determine the deep learning-based overlap ratio r_{i,j}^{D} for each deep learning-based detection object Dᵢ, to sum the deep learning-based overlap ratio r_{i,j}^{D} for each deep learning-based detection object Dᵢ, to determine whether the sum is greater than a predetermined reference value t_{D,l} (S301).

In response to a case where the sum of the deep learning-based overlap ratios r_{i,j}^{D} is equal to or smaller than the predetermined reference value t_{D,l}, the object detection apparatus 100 may be configured to determine that the deep learning-based detection object Dᵢ is misdetected and delete the deep learning-based detection object Dᵢ (S302).

In response to a case where the sum of the deep learning-based overlap ratios r_{i,j}^{D} is greater than the predetermined reference value t_{D,l}, the object detection apparatus 100 may be configured to determine that the deep learning-based detection object Dᵢ has been detected normally and to allow the deep learning-based detection object Dᵢ to be included in the object detection result (S303).

The above steps S301, S302 and S303 are intended to ameliorate a risk of misdetection in the result of deep learning object detection. That is, the sum of the deep learning-based overlap ratios r_{i,j}^{D} may improve object detection performance by use of the result of the signal processing-based object detection which is more reliable for areas with actual objects than the result of deep learning-based detection, and by processing deep learning-based detection objects Dᵢ as false detections and excluding them from an object detection result thereof.

Next, the object detection apparatus 100 may be configured to determine whether the result of deep learning object detection is not detected through a signal processing-based detection object Sⱼ and a reliable deep learning-based detection object Dᵢ, and to replace an non-detected area with a signal processing-based detection object.

Accordingly, the object detection apparatus 100 may be configured to determine whether the signal processing-based overlap ratio r_{i,j}^{S} of all signal processing-based detection objects Sⱼ is less than a predetermined reference value t_{S,l} (S401).

In response to a case where a signal processing-based overlap ratio r_{i,j}^{S} of all signal processing-based detection objects Sⱼ is smaller than the predetermined reference value t_{S,l}, the object detection apparatus 100 may be configured to determine that the object has not been detected based on deep learning and to allow the corresponding signal processing-based detection object Sⱼ to be included in the object detection result (S402).

On the other hand, in response to a case where the signal processing-based overlap ratio r_{i,j}^{S} of the signal processing-based detection object Sⱼ is not smaller than the predetermined reference value t_{S,l}, the object detection apparatus 100 may be configured to sum the signal processing-based overlap ratio r_{i,j}^{S} of the signal processing-based detection objects Sⱼ and determines whether the sum is greater than the predetermined reference value t_{S,h} (S403).

In response to a case where the sum of signal processing-based overlap ratios r_{i,j}^{S} is greater than the predetermined standard value t_{S,h}, the object detection apparatus 100 may be configured to use the deep learning-based detection object as an object detection result because an overlap area between the deep learning-based detection object and the signal processing-based detection object is large. Accordingly, the object detection apparatus 100 may be configured to exclude a corresponding signal processing-based detection object Sⱼ from the object detection result (S404). That is, in a case where the sum of signal processing-based overlap ratios r_{i,j}^{S} is greater than the predetermined reference value t_{S,h}, this may indicate that most areas are covered by the deep learning detection result.

In response to a case where the sum of the signal processing-based overlap ratios r_{i,j}^{S} is equal to or smaller than the predetermined reference value t_{S,h}, the object detection apparatus 100 may be configured to allow a corresponding signal processing-based detection object Sⱼ to be included in the object detection result (S405). In the instant case, in response to a case where the sum of the signal processing-based overlap ratios r_{i,j}^{S} is equal to or smaller than the predetermined reference value t_{S,h}, a signal processing-based detection object Sⱼ may indicate an object in which some areas may be replaced by a deep learning-based detection result.

Thereafter, the object detection apparatus 100 may be configured to generate point information of the deep learning object detection result by transferring a signal processing-based detection point of an overlap area between the signal processing-based detection object Sⱼ and the deep learning-based detection object Dᵢ to the deep learning-based detected object (S406).

This is because the box of the signal processing-based detection object includes points, but there is no point information in the box of the deep learning-based detection object. Accordingly, point information of the deep learning object detection result may be generated by moving a point of the overlap area of the signal processing-based detection object and the deep learning-based detection object to the box of the deep learning-based detection object.

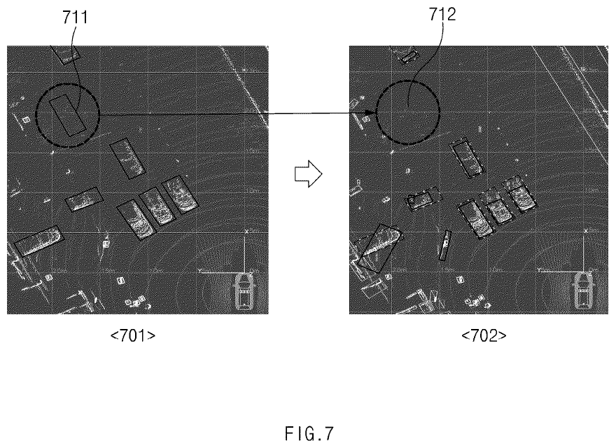

FIG. 7 illustrates an example of ameliorating a misdetection phenomenon of an object detection technique based on deep learning.

Referring to FIG. 7, a view 701 shows the deep learning-based object detection result, and a view 702 shows a final LiDAR object detection result through fusion of the signal processing-based object detection result and the deep learning-based object detection result. In the view 701, in a case where a detection result occurred in an area 711 with few points, a risk of misrecognition is high, it may be seen that the misrecognized object is removed in the view 702 (see 712). Accordingly, a misdetection phenomenon may be improved in response to detecting objects based on deep learning.

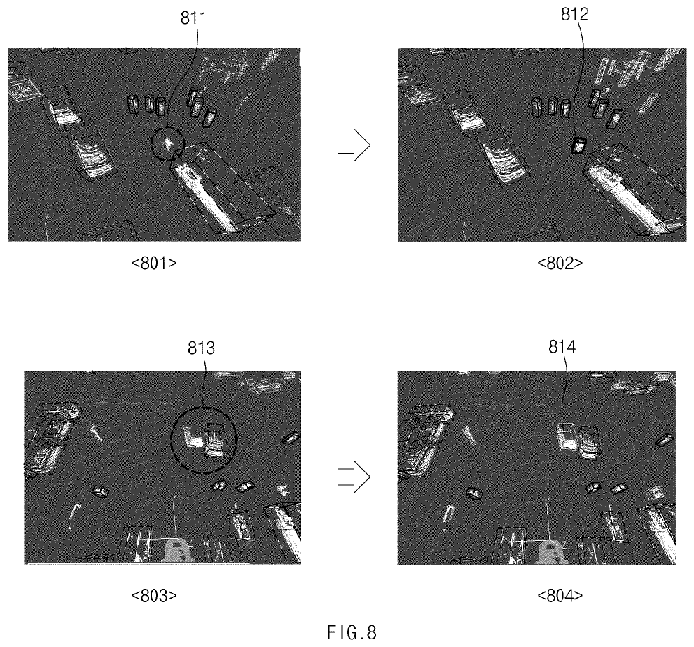

FIG. 8 illustrates an example of ameliorating a non-detection phenomenon of an object detection technique based on deep learning.

Referring to FIG. 8, views 801 and 803 show the deep learning-based object detection result, and views 802 and 804 show a final LiDAR object detection result through fusion of the signal processing-based object detection result and the deep learning-based object detection result.

It may be seen that objects 811 and 813 were not recognized in the views 801 and 802, but objects 812 and 814 were recognized and displayed as boxes in the views 802 and 804.

Accordingly, in a case where non-recognition occurs in the deep learning object detection result, the non-detection phenomenon may be prevented through the signal processing-based object detection result. That is, the non-detection phenomenon, which may not be completely prevented due to characteristics of a deep learning-based object detection technique, may be compensated for through a signal processing-based result with almost no non-detection.

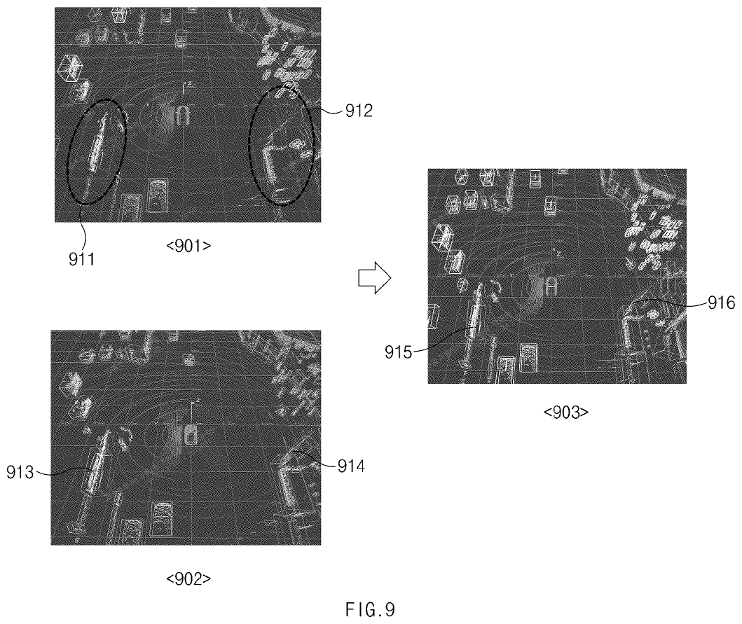

FIG. 9 illustrates an example of an object detection result for an irregular object.

Referring to FIG. 9, a view 901 shows the deep learning-based object detection result, a view 902 is the signal processing-based object detection result, and a view 903 shows a final LiDAR object detection result through fusion of the signal processing-based object detection result and the deep learning-based object detection result.

It may be seen that atypical objects 911 and 912 were not detected in the view 901, but atypical objects 913 and 914 were detected in the view 902. Accordingly, it may be seen that atypical objects 915 and 916 are displayed in the view 903.

In the present way, recognition results for atypical objects, which is a limitation of the deep learning object detection technique, may be secured through signal processing convergence.

That is, according to an exemplary embodiment of the present disclosure, in a case of the deep learning object detection technique, it shows high recognition performance for objects with standardized shapes (vehicles, pedestrians, motorcycles, etc.), but it is difficult to secure learning performance for unstructured objects (guardrails, unstructured obstacles, etc.), and in a case of these unstructured objects, recognition results of irregular objects are generated by fusing a deep learning-based detection object recognition result and a signal processing-based detection object recognition result.

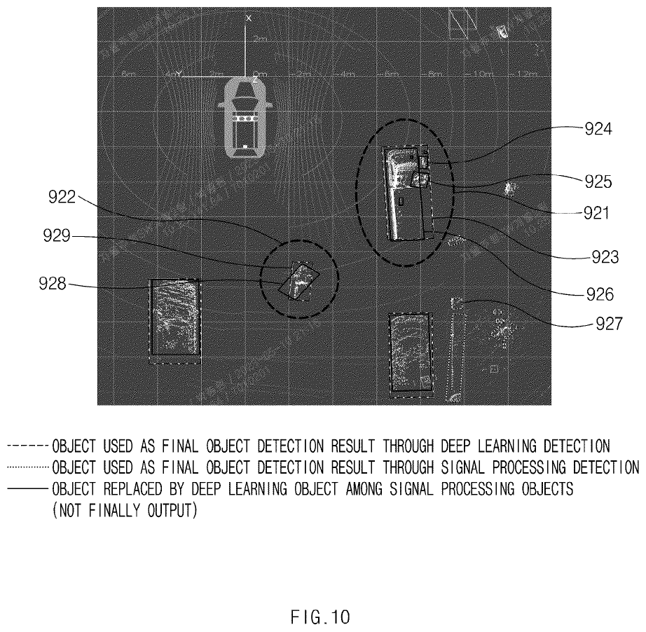

FIG. 10 illustrates an example of a final LiDAR object detection result through fusion of an object detection result based on signal processing and an object detection result based on deep learning.

This is because position and posture accuracy of objects is generally superior in the case of deep learning-based object detection compared to signal processing-based object detection, and thus, an approach of using the deep learning object detection result as a main method through a fusion algorithm provided in an exemplary embodiment of the present disclosure and supplementing insufficient portions through signal processing is advantageous in terms of performance.

It may be seen that an object 921 in FIG. 10 is divided into several small boxes 924 and 925 and a large box 926, which is a situation where the vehicle is separated into a plurality of objects due to limitations in segmentation performance of signal processing-based object detection. On the other hand, in response to detecting a deep learning-based object, the present object is detected as a single box 923. Accordingly, the object detection apparatus 100 may be configured to use the box 923, which is a deep learning-based object detection result, as a final object detection result.

In the present way, the object detection apparatus 100 may be configured to recognize points of actual vehicles as one through fusion of a signal processing-based detection object and a deep learning-based detection object, and to find out more accurate size and posture.

Furthermore, the object detection apparatus 100 may be configured to use an object 927, which was not detected during deep learning detection but was detected through signal processing detection, as a final detection result.

In a case of the signal processing-based object detection technique in a small object (e.g., motorcycle) for an object 922, it is difficult to accurately determine a posture thereof, this is an example of outputting a more accurate posture using the deep learning-based object detection result. That is, it may be seen that a heading direction of an object 928 in a case of being detected based on signal processing is different from a heading direction of an object 929 in a case of being detected based on deep learning.

The object detection apparatus 100 may determine that accuracy of posture information of the object is low during signal processing-based detection based on signal processing, and select the posture information during deep learning-based detection instead of the posture information of the object during the signal processing-based detection to use a box 929 of the object as the final detection result.

In the present way, according to an exemplary embodiment of the present disclosure, object detection performance may be improved by use of both the deep learning-based object detection technique and the signal processing-based object detection technique.

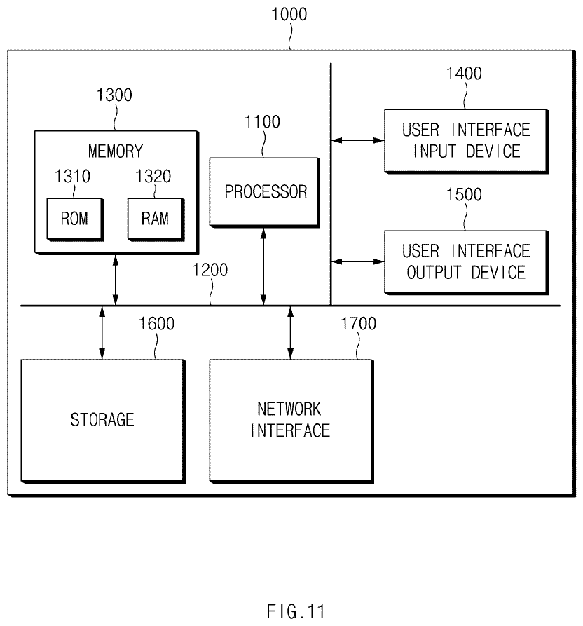

FIG. 11 illustrates an computing system associated with an object detection apparatus or an object detection method.

Referring to FIG. 11, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device which is configured to perform processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An object detection apparatus including:
a processor configured to detect an object based on deep learning using data obtained from Light Detection and Ranging (LiDAR) and to detect the object based on signal processing; and
a storage operatively connected to the processor and configured to store algorithms and data driven by the processor,
wherein the processor is configured to output a final object detection result by fusing a result of the detecting based on the deep learning and a result of the detecting based on the signal processing.

2. The object detection apparatus of claim 1, wherein the processor is further configured:
to perform bounding box processing on the object detected based on the deep learning and the object detected based on the signal processing,
to determine an overlap ratio between a box of the object detected based on the deep learning and a box of the object detected based on the signal processing, and
to determine association between the object detected based on the deep learning and the object detected based on the signal processing.

3. The object detection apparatus of claim 1, wherein the processor is further configured:
to determine a deep learning-based overlap ratio based on the result of the detecting based on the deep learning, and
to determine a signal processing-based overlap ratio based on the result of the detecting based on the signal processing.

4. The object detection apparatus of claim 3, wherein the processor is further configured to determine the deep learning-based overlap ratio and the signal processing-based overlap ratio by use of a total area of a box of the object detected based on the deep learning, a total area of a box of the object detected based on the signal processing, and an overlap area between the box of the object detected based on the deep learning and the box of the object detected based on the signal processing.

5. The object detection apparatus of claim 4, wherein the processor is further configured to determine the signal processing-based overlap ratio by dividing the overlap area between the box of the object detected based on the deep learning and the box of the object detected based on the signal processing by a sum of the overlap area of the box of the object detected based on the deep learning and the box of the object detected based on the signal processing, and the total area of the box of the object detected based on the deep learning.

6. The object detection apparatus of claim 4, wherein the processor is further configured to determine the deep learning-based overlap ratio by dividing the overlap area between the box of the object detected based on the deep learning and the box of the object detected based on the signal processing by a sum of the overlap area of the box of the object detected based on the deep learning and the box of the object detected based on the signal processing, and the total area of the box of the object detected based on the signal processing.

7. The object detection apparatus of claim 5, wherein the processor is further configured:
to sum up the deep learning-based overlap ratio for each object detected based on the deep learning, and
to determine whether each detected object was misdetected based on the deep learning by use of a sum of deep learning-based overlap ratios.

8. The object detection apparatus of claim 7, wherein the processor is further configured:
to allow the object detected based on the deep learning to be included in an object detection result in response to a case where the sum of the deep learning-based overlap ratios is greater than a predetermined reference value, and
to remove the object detected based on the deep learning from the object detection result in response to a case where the sum of the deep learning-based overlap ratios is equal to or smaller than the predetermined reference value.

9. The object detection apparatus of claim 8, wherein the processor is further configured to output a final object detection result by fusing the object detected based on the deep learning and the object detected based on the signal processing included in the object detection result.

10. The object detection apparatus of claim 8, wherein the processor is further configured to determine whether each signal processing-based overlap ratio for each object detected based on the signal processing is smaller than a predetermined reference value.

11. The object detection apparatus of claim 10, wherein the processor is further configured to allow objects detected based on the signal processing to be included in the object detection result in response to a case where the signal processing-based overlap ratio for each object detected based on the signal processing is smaller than the predetermined reference value.

12. The object detection apparatus of claim 11, wherein the processor is further configured,
in response to a case where there is a value greater than the predetermined reference value among the signal processing-based overlap ratios for each object detected based on the signal processing,
to determine whether the object detected based on the signal processing is not detected by use of the sum of the signal processing-based overlap ratios for each object detected based on the signal processing.

13. The object detection apparatus of claim 12, wherein the processor is further configured to remove the object detected based on the signal processing from the object detection result and output the final object detection result using the object detected based on the deep learning in response to a case where the sum of the signal processing-based overlap ratios for each object detected based on the signal processing is greater than the predetermined reference value.

14. The object detection apparatus of claim 13, wherein the processor is further configured to allow the object detected based on the signal processing to be included in the object detection result in response to a case where the sum of signal processing-based overlap ratios for each object detected based on the signal processing is equal to or smaller than the predetermined reference value.

15. The object detection apparatus of claim 14, wherein the processor is further configured to transfer points of the overlap area between the object detected based on the signal processing and the object detected based on the deep learning to the object detected based on the deep learning.

16. An object detection method comprising:
detecting, by a processor, an object based on deep learning using data obtained from Light Detection and Ranging (LiDAR) and detecting the object based on signal processing; and
outputting, by the processor, a final object detection result by fusing a result of the detecting based on the deep learning and a result of the detecting based on the signal processing.

17. The object detection method of claim 16,
wherein the detecting of the object includes performing, by the processor, bounding box processing on the object detected based on the deep learning and the object detected based on the signal processing, and
wherein the outputting of the final object detection result includes determining, by the processor, a deep learning-based overlap ratio and a signal processing-based overlap ratio by use of a total area of the box of the object detected based on the deep learning, a total area of the box of the object detected based on the signal processing, and an overlap area between the box of the object detected based on the deep learning and the box of the object detected based on the signal processing.

18. The object detection method of claim 17, wherein the outputting of the final object detection result further includes:
summing up, by the processor, the deep learning-based overlap ratio for each object detected based on the deep learning; and
determining, by the processor, whether each detected object was misdetected based on the deep learning by use of a sum of deep learning-based overlap ratios.

19. The object detection method of claim 18, wherein the outputting of the final object detection result further includes:
allowing, by the processor, the object detected based on the deep learning to be included in an object detection result in response to a case where the sum of the deep learning-based overlap ratios is greater than a predetermined reference value; and
removing, by the processor, the object detected based on the deep learning from the object detection result in response to a case where the sum of the deep learning-based overlap ratios is equal to or smaller than the predetermined reference value.

20. The object detection method of claim 19, wherein the outputting of the final object detection result further includes:
determining, by the processor, whether each signal processing-based overlap ratio for each object detected based on the signal processing is smaller than a predetermined reference value;
allowing, by the processor, objects detected based on the signal processing to be included in the object detection result in response to a case where the signal processing-based overlap ratio for each object detected based on the signal processing is smaller than the predetermined reference value and
determining, by the processor, whether the object detected based on the signal processing is not detected by use of the sum of the signal processing-based overlap ratios for each object detected based on the signal processing in response to a case where there is a value greater than the predetermined reference value among the signal processing-based overlap ratios for each object detected based on the signal processing.
